(19) United States
(12) Patent Application Publication
(10) Pub. No.: US 2009/0292837 A1
(43) Pub. Date: Nov. 26, 2009

(54) PROPAGATION PATH SPECIFYING DEVICE, PROPAGATION PATH SPECIFYING METHOD AND COMPUTER PROGRAM PRODUCT

(76) Inventor: Hisaaki KATAGIRI, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/252,572

(22) Filed: Oct. 16, 2008

(30) Foreign Application Priority Data
May 26, 2008 (JP) P2008-137302

(51) Int. Cl. G06F 3/00

(52) U.S. Cl. 710/38

(57) ABSTRACT

A propagation path specifying device includes: a storing unit storing first information correspondingly indicating signal changes occurring in the input terminals and output terminals of the plurality of logic elements and occurring times of the signal changes; a storing unit storing second information indicating a connection relation among a plurality of logic elements having one or more input terminals and output terminals; a storing unit storing third information indicating a correspondence of signals in the input terminal and output terminal of the logic element; an input unit inputting information to select the output terminal of the plurality of logic elements and the occurring time from the first information; and a propagation path specifying unit retroactively specifying a propagation path of the signal change in the selected output terminal and at the selected occurring time, based on the first to third information.

### CROSS-REFERENCE TO THE INVENTION

This application is based upon and claims the benefit of priority from the prior Japanese Patent Application No. 2008-137302, filed on May 26, 2008; the entire contents of which are incorporated herein by reference.

### BACKGROUND OF THE INVENTION

1. Field of the Invention

The present invention relates to a propagation path specifying device, a propagation path specifying method and a computer program product for specifying a propagation path of a signal change having caused a signal change (event), for the signal change in a logic circuit.

2. Description of the Related Art

An action of a logic circuit is sometimes simulated by an HDL (Hardware Description Language) and the like. Conventionally, a propagation path of a signal change having caused an indefinite signal change occurring at a time of a logic simulation of the logic circuit described by the HDL and the like is specified by manpower. Accordingly, there is proposed a method to automatically specify a propagation path of a signal change having caused an indefinite signal change by recording signal change propagation information including a pointer to a propagation source of the signal change and a pointer to a propagation destination of the signal change and referring to this signal change propagation information (see JP-A 11-15864 (KOKAI)).

### BRIEF SUMMARY OF THE INVENTION

In order to specify a propagation path of a signal change, a conventional propagation path specifying device requires signal change propagation information including information (hereinafter, referred to as link information) of a pointer to a propagation source and a pointer to a propagation destination, so that a large amount of information is to be recorded. In consideration of the above problems, an object of the present invention is to obtain a propagation path specifying device, a propagation path specifying method and a computer program product capable of specifying a propagation path of a signal change having caused an arbitrary signal change without using the link information and with a small amount of information.

A propagation path specifying device according to an embodiment of the present invention includes: a storing unit storing first information correspondingly indicating signal changes occurring in the input terminals and output terminals of the plurality of logic elements and occurring times of the signal changes; a storing unit storing second information indicating a connection relation among a plurality of logic elements having one or more input terminals and output terminals; a storing unit storing third information indicating a correspondence of signals in the input terminal and output terminal of the logic element; an input unit inputting information to select the output terminal of the plurality of logic elements and the occurring time from the first information; and a propagation path specifying unit retroactively specifying a propagation path of the signal change in the selected output terminal and at the selected occurring time, based on the first to third information.

A propagation path specifying method according to an embodiment of the present invention includes: inputting, from first information correspondingly indicating signal changes occurring in input terminals and output terminals of a plurality of logic elements having one or more input terminals and output terminals and occurring times of the signal changes, information to select the output terminal of the plurality of logic elements and the occurring time; and retroactively specifying a propagation path of the signal change in the selected output terminal and at the selected occurring time, based on the first information, second information indicating a connection relation among the plurality of logic elements and third information indicating a correspondence between signals of the input terminal and output terminal of the logic element.

A computer program product according to an embodiment of the present invention includes: a computer readable code for causing the computer to act as a storing unit storing first information correspondingly indicating signal changes occurring in the input terminals and output terminals of the plurality of logic elements and occurring times of the signal changes; a computer readable code for causing a computer to act as a storing unit storing second information indicating a connection relation among a plurality of logic elements having one or more input terminals and output terminals; a computer readable code for causing the computer to act as a storing unit storing third information indicating a correspondence between signals of the input terminal and output terminal of the logic element; a computer readable code for causing the computer to act as an input unit inputting information to select the output terminal of the plurality of logic elements and the occurring time from the first information; and a computer readable code for causing the computer to act as a propagation path specifying unit retroactively specifying a propagation path of the signal change in the selected output terminal and at the selected occurring time based on the first to third information.

### BRIEF DESCRIPTION OF THE DRAWINGS

FIG. 1 is a diagram showing a hardware configuration of a propagation path specifying device according to a first embodiment.

FIG. 2 is a functional block diagram of the propagation path specifying device according to the first embodiment.

FIG. 3A is a diagram showing an AND circuit.

FIG. 3B is a diagram showing an OR circuit.

FIG. 3C is a diagram showing a NOT circuit.

FIG. 3D is a diagram showing an XOR circuit.

FIG. 3E is a diagram showing an NOR circuit.

FIG. 3F is a diagram showing a NAND circuit.

FIG. 4 is a diagram showing a D-type flip-flop.

FIG. 5A is a diagram showing a multiplexer.

FIG. 5B is a diagram showing a half adder.

FIG. 6 is a diagram showing an example of a net list generated in the first embodiment.

FIG. 7 is a chart showing a simulation result in the first embodiment by a timing chart.

FIG. 8 is a chart showing an example of a dump file generated in the first embodiment.

FIG. 9 is a flowchart showing actions of the propagation path specifying device at a logic simulation time.

FIG. 10 is a flowchart showing actions of the propagation path specifying device at a signal change propagation path specifying time.

FIG. 11 is a flowchart showing detailed actions of a propagation path specifying unit.

FIG. 12 is a diagram showing and example of an RTL.

### DESCRIPTION OF THE EMBODIMENTS

Hereinafter, an embodiment of the present invention will be described in detail with reference to the drawings.

### First Embodiment

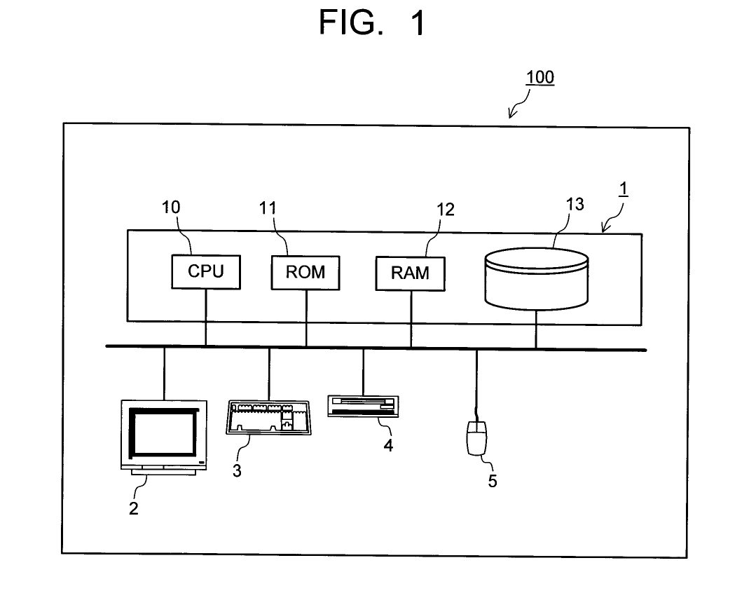

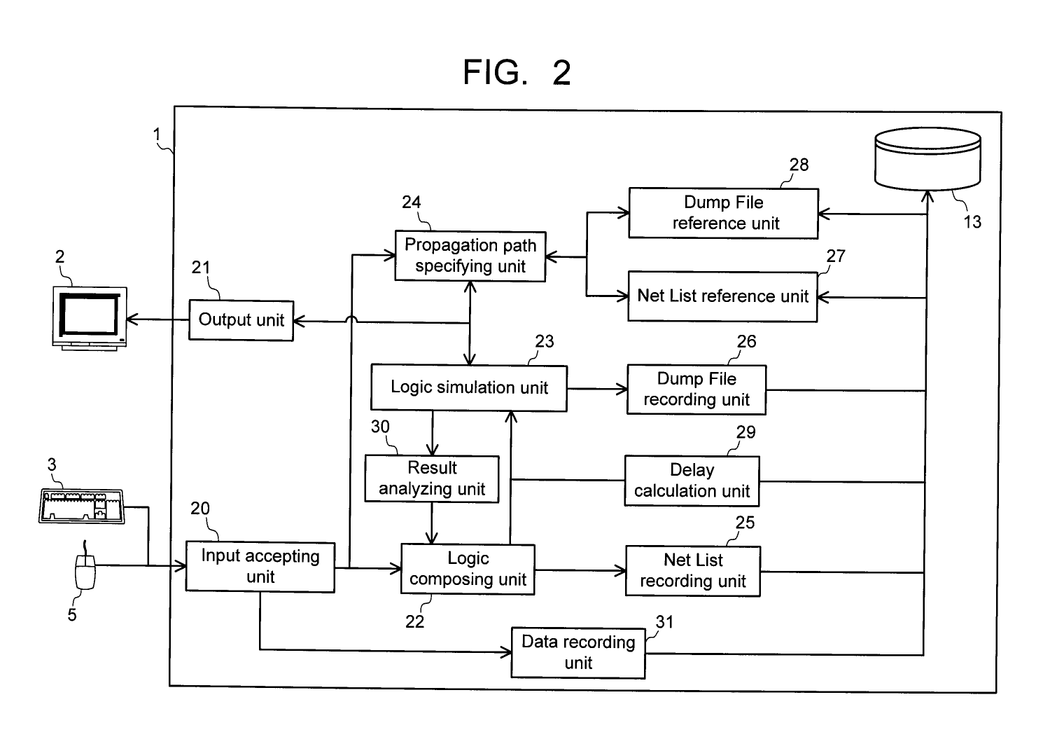

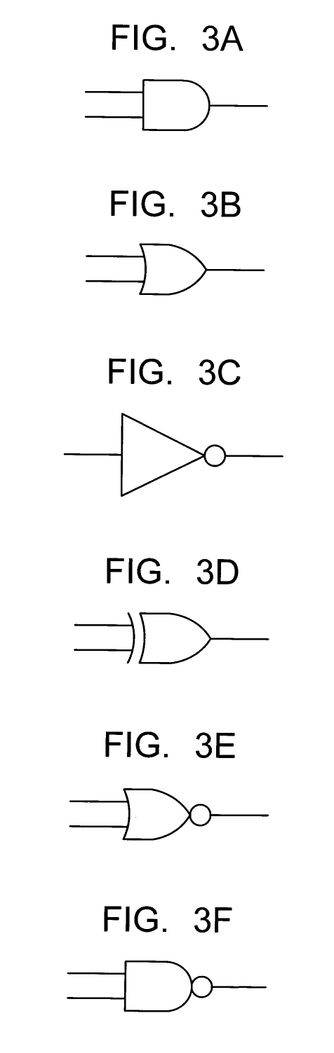

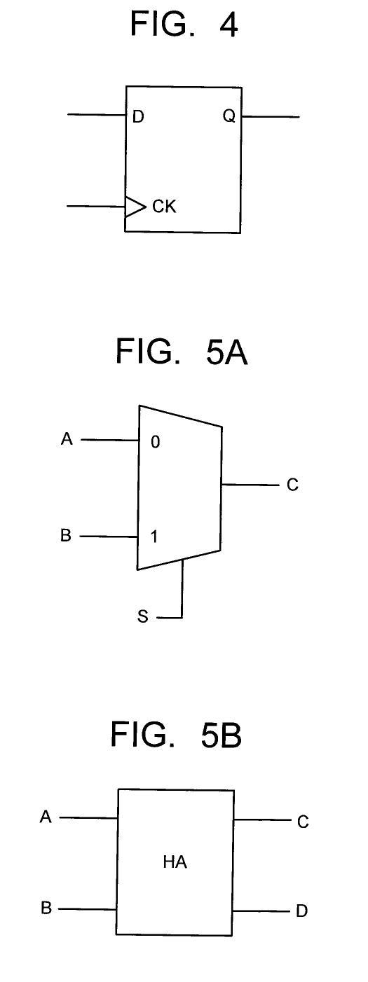

FIG. 1 is a diagram showing a hardware configuration of a propagation path specifying device 100 according to a first embodiment. FIG. 2 is a functional block diagram of the propagation path specifying device 100. FIG. 3A is a diagram showing an AND (logical multiplication) circuit. FIG. 3B is a diagram showing an OR (logical sum) circuit. FIG. 3C is a diagram showing a NOT (inverter) circuit. FIG. 3D is a diagram showing an XOR (exclusive logical sum)circuit. FIG. 3E is an NOR (negative logical sum) circuit. FIG. 3F is a diagram showing a NAND (negative logical multiplication) circuit. FIG. 4 is a diagram showing a D (Delay) type flip-flop. FIG. 5A is a diagram showing a multiplexer. FIG. 5B is a diagram showing a half adder.

The propagation path specifying device 100 including the above-described components is constituted with a computer system including a CPU 10, a ROM 11, a RAM 12, an HDD 13, a display 2, a keyboard 3, an FDD 4, a mouse 5 and the like which are shown in FIG. 1. The propagation path specifying device 100 can be also constituted with simulator software in which application software realizing a function of each unit is integrated as a tool.

A computer main body 1 includes the CPU (Central Processing Unit) 10, the ROM (Read Only Memory), the RAM (Random Access Memory) 12, the HDD (Hard Disk Drive) 13, and the like. The ROM 11 stores an action code of the CPU 10. The RAM 12 is used as a working area of the CPU 10. The HDD 13 records a computer program to perform a logic simulation, a computer program to specify a propagation path of an arbitrary signal change, and the like. The CPU 10 loads the computer program recorded in the HDD 13 to the RAM 12 and execute the computer program, whereby the CPU 10 performs a logic simulation or specifying of the propagation path of the arbitrary signal change.

The display 2 displays results of the above-described logic simulation or specifying of the propagation path of the arbitrary signal change. The keyboard 3 and the mouse 5 output an accepted input operation to the computer main body 1. The disk drive 4 performs reading of data recorded in a recording medium such as an FD (Floppy Disk) and an optical disk CD (Compact Disk) or DVD (Digital Versatile Disk) and writing of data into the recording medium.

An input accepting unit 20 accepts design data or a logical formula (hereinafter, functional description) written in an HDL, a truth table, a propagation delay time of a signal change, and data of a test pattern and data to select an arbitrary signal change, which are inputted from the keyboard 3 or the mouse 5.

The input accepting unit 20 outputs the functional description to a logic composing unit 22, outputs the truth table, a propagation delay time of the signal change and the data of the test pattern to a data recording unit 31, and outputs the data to select an arbitrary signal change to a propagation path specifying unit 24. These pieces of data can be downloaded from the disk drive 4 or can be recorded in the HDD 13 in advance.

The data recording unit 31 records the truth table, the propagation delay time of the signal change and the data of the test pattern which have been outputted from the input accepting unit 20 into the HDD 13. Here, the propagation delay time of the signal change is used for a calculation of the propagation delay time in a result analyzing unit 30. The truth table and the data of the test pattern are used in the logic simulation in a logic simulation unit 23.

The logic composing unit 22 generates a net list being a logic circuit diagram of a gate level, based on the functional description outputted from the input accepting unit 20. As a logic element described in this net list, there are cited a basic logic gate such as the AND circuit, the OR circuit, the NOT circuit, the XOR circuit, the NOR circuit, and the NAND circuit which are shown in FIG. 3A to FIG. 3F, a storage logic gate such as the D-type flip-flop shown in FIG. 4, and a macro such as the multiplexer shown in FIG. 5A and the half adder shown in FIG. 5B.

It should be noted that the basic logic gate, the storage logic gate and the macro which are shown in FIG. 3A to FIG. 5B are examples of the logic element used in the first embodiment, and, for instance, there are other flip-flops in addition to the D-type shown in FIG. 4, such as an RS (Reset Set) type, a JK (Jack Kilby) type, a T type (counter), and the like. This net list has information such as a logical formula, a connection relation and a disposed position of each logic element.

Here, the logic composing unit 22 generates the net list by performing a recognizing processing of a logical formula to recognize a logical formula describing an action of each logic element, a logic conversion processing to convert a description of the logical formula to each logic element corresponding thereto, a replacement processing to retrieve a not-shown cell library in accordance with a design condition and replace each logic element with each logic element that corresponds to the design condition, and an optimization processing to alter each logic element to an optimum element.

A net list recording unit 25 records the net list generated in the logic composing unit 22 into the HDD 13. It should be noted that a circuit diagram editor can be used, in addition to logic composing, for generation of the net list. The circuit diagram editor is a tool to generate a circuit diagram on a display by using an actual gate in accordance with an action of a circuit to be designed. Further, the net list can be designed by a manual input based on an actual circuit diagram.

A delay calculation unit 29 calculates a propagation delay time of each logic element based on the propagation delay time of the signal change (hereinafter, referred to as a propagation delay time) having been recorded into the HDD 13 by the data recording unit 31. The propagation delay time calculated here is used for a simulation calculation in the logic simulation unit 23. It is also possible to record a propagation delay time specific to each logic element as a delay time file in advance, and add a coefficient due to variation of temperature, a power supply voltage and a process and a capacitance of wiring to this delay time file, and calculate a propagation delay time of each signal.

The logic simulation unit 23 gives a logic circuit generated by the logic composing unit 22 an input signal based on the test pattern, based on the truth table and the data of the test pattern recorded into the HDD 13 by the data recording unit 31 and the propagation delay time calculated by the delay calculation unit 29, whereby the logic simulation unit 23 simulates the signal change of that logic circuit.

The result analyzing unit 30 analyzes, in a simulation result in the logic simulation unit 23, whether an output signal is of an expected value for the input signal that has been given, and whether an action is performed as designed in conformity with a clock signal, and so on. If the simulation result does not satisfy the expected value which has been planned, a logic circuit is newly generated again by the logic composing unit 22 and this logic circuit is simulated.

A dump file recording unit 26 records the simulation result by the logic simulation unit 23 into the HDD 13 in a predetermined file format (hereinafter, the simulation result recorded into the HDD 13 is referred to as a dump file). The propagation path specifying unit 24 specifies the propagation path of the signal change having caused the arbitrary signal change accepted by the input accepting unit 20.

A net list reference unit 27 refers to the net list recorded in the HDD 13 by an instruction from the propagation path specifying unit 24. A dump file reference unit 28 refers to the dump file recorded in the HDD 13 by an instruction from the propagation path specifying unit 24.

An output unit 21 outputs the simulation result by the logic simulation unit 23 and the specifying result of the propagation path of the signal change by the propagation path specifying unit 24 to the display 2. The display 2 displays the simulation result and the specifying result of the propagation path of the signal change which are outputted from the output unit 21.

### (Actions at Logic Simulation)

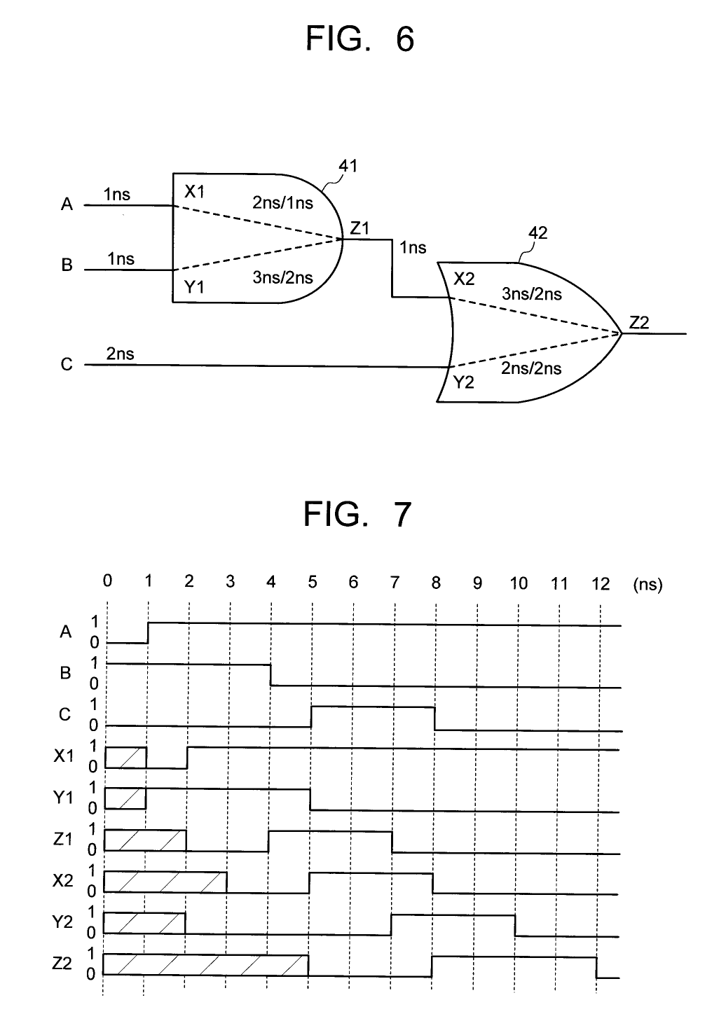

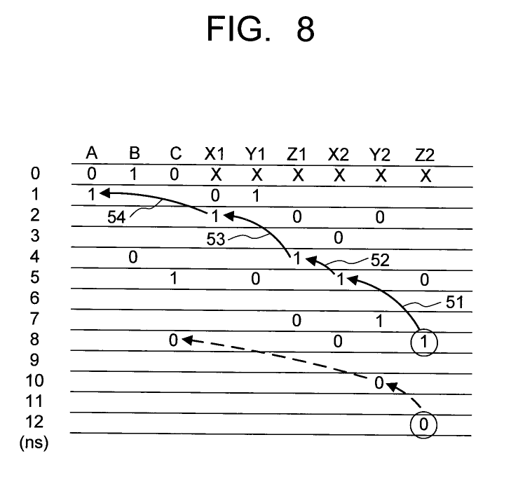

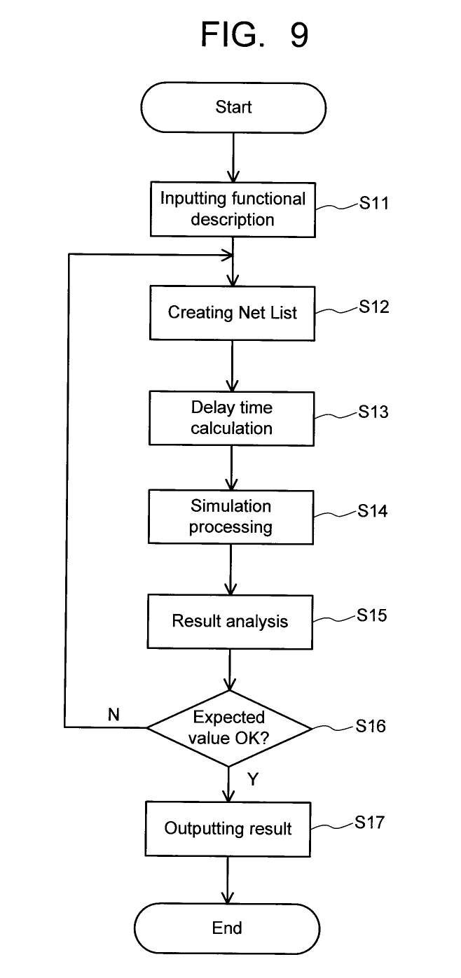

FIG. 6 is a diagram showing an example of the net list generated in the first embodiment. FIG. 7 is a chart showing the simulation result of this embodiment in a form of a timing chart. FIG. 8 is a chart showing an example of the dump file generated in this embodiment. FIG. 9 is a flowchart showing actions of the propagation path specifying device 100 at the logic simulation. Hereinafter, the actions of the propagation path specifying device 100 at the logic simulation time will be explained by using FIG. 6 to FIG. 9.

First, the input accepting unit 20 outputs the accepted functional description to the logic composing unit 22 (step S11). The input accepting unit 20 also outputs the truth table, the propagation delay time of the signal change and the data of the test pattern to the data recording unit 31. The data recording unit 31 records the truth table, the propagation delay time of the signal change and the data of the test pattern into the HDD 13.

The logic composing unit 22 generates the net list based on the functional description outputted from the input accepting unit 20 (step S12). The delay calculation unit 29 calculates a delay time of a logic circuit described in the net list generated by the logic composing unit 22 based on the propagation delay time of the signal change recorded into the HDD 13 by the data recording unit 31 (step S13).

In this embodiment, it is assumed that the net list shown in FIG. 6 is generated by the logic composing unit 22. It should be noted that though the propagation delay time is not included in the information of the net list, the propagation delay time is indicated along with the net list in FIG. 6, for the sake of explanation.

The logic circuit described in the net list shown in FIG. 6 includes an AND circuit 41 and an OR circuit 42. The AND circuit 41 includes input terminals X1, Y1 and an output terminal Z1. The OR circuit 42 includes input terminals X2, Y2 and an output terminal Z2. A signal is inputted from a specific point A to the input terminal X1. A signal is inputted from a specific point B to the input terminal Y1. A signal is inputted from the output terminal Z1 to the input terminal X2. A signal is inputted from a specific point C to the input terminal Y2. Here, the specific points A to C are arbitrary points on the net list created by the logic composing unit 22.

Further, in this embodiment, it is assumed that the following propagation delay time is calculated by the delay calculation unit 29. A unit of this propagation delay time is 1 ns (nanosecond). A propagation delay time from the specific point A to the input terminal X1 at a signal rise time and at a signal fall time: 1 ns. A propagation delay time from the specific point B to the input terminal Y1 at a signal rise time and at a signal fall time: 1 ns. A propagation delay time from the input terminal X1 to the output terminal Z1 at a signal rise time: 2 ns. A propagation delay time from the input terminal X1 to the output terminal Z1 at a signal fall time: 1 ns. A propagation delay time from the input terminal Y1 to the output terminal Z1 at a signal rise time: 3 ns. A propagation delay time from the input terminal Y1 to the output terminal Z1 at a signal fall time: 2 ns.

A propagation delay time from the output terminal Z1 to the input terminal X2 at a signal rise time and at a signal fall time: 1 ns. A propagation delay time from the specific point C to the input terminal Y2 at a signal rise time and at a signal fall time: 2 ns. A propagation delay time from the input terminal X2 to the output terminal Z2 at a signal rise time: 3 ns. A propagation delay time from the input terminal X2 to the output terminal Z2 at a signal fall time: 2 ns. A propagation delay time from the input terminal Y2 to the output terminal Z2 at a signal rise time: 2 ns. A propagation delay tine from the input terminal Y2 to the output terminal Z2 at a signal fall time: 2 ns.

The logic simulation unit 23 gives the logic circuit described in the net list shown in FIG. 6 an input signal based on the truth table and the data of the test pattern recorded into the HDD 13 by the data recording unit 31, whereby the logic simulation unit 23 performs the simulation processing (step S14). In this embodiment, it is assumed that the input signals of the following patterns are given to the specific points A to C. A unit of the time is ns (nanosecond). The specific point A: a signal is inputted at a time that 1 ns passes since a start of a test. The specific point B: a signal is inputted at the start of the test and makes the signal fall at a time that 4 ns pass. The specific point C: a signal is inputted at a time that 5 ns pass since the start of the test and the signal is made to fall at a time of 8 ns.

FIG. 7 is the chart showing the simulation result at times that the signals of the above-described patterns are inputted in the form of the timing chart. In FIG. 7, an elapsed time (unit: ns) since the start of the test is indicated in a horizontal axis, while the input terminal X1 to the output terminal Z2 are indicated in a vertical axis. A cycle of rise and fall of a clock signal in this timing chart is 1 ns (nanosecond).

A value “1” shown in FIG. 7 indicates a state that a signal is inputted. A value “0” (zero) indicates a state that a signal is not inputted. An oblique line portion in FIG. 7 indicates that a state is indefinite, with a signal not being inputted to the input terminal X1 to the output terminal Z2. Hereinafter the simulation result shown in FIG. 7 will be explained.

The input terminal X1: a signal rises at a time of 2 ns. It is because the signal is inputted to the specific point A at a time that 1 ns passes since the start of the test and the propagation delay time from the specific point A to the input terminal X1 is 1 ns.

The input terminal Y1: a signal falls at a time of 5 ns. It is because the signal is inputted to the specific point B at the time of the test start, the signal inputted to the specific point B is made to fall at a time that 4 ns passes, and the propagation delay time from the specific point B to the input terminal Y1 is 1 ns.

The output terminal Z1: a signal rises at a time of 4 ns and the signal falls at a time of 7 ns. It is because the signal rises at the time of 2 ns in the input terminal X1 and the propagation delay time from the input terminal X1 to the output terminal Z1 at the signal rise time is 2 ns. It is also because the signal falls at a time of 5 ns in the input terminal Y1 and the propagation delay time from the input terminal Y1 to the output terminal Z1 at the signal fall time is 2 ns.

The input terminal X2: a signal rises at the time of 5 ns and the signal falls at a time of 8 ns. It is because the signal rises at the time of 4 ns and the signal falls at the time of 7 ns in the output terminal Z1, and the propagation delay time from the output terminal Z1 to the input terminal X2 is 1 ns.

The input terminal Y2: a signal rises at the time of 7 ns and the signal falls at a time of 10 ns. It is because the signal is inputted to the specific point C at the time that 5 ns pass since the start of the test and the signal inputted to the specific point C is made to fall at the time of 8 ns, and the propagation delay time from the specific point C to the input terminal Y2 is 2 ns.

The output terminal Z2: a signal rises at the time of 8 ns and the signal falls at the time of 12 ns. It is because the signal rises at the time of 5 ns in the input terminal X2 and the propagation delay time from the input terminal X2 to the output terminal Z2 at the signal rise time is 3 ns. It is further because the signal rises at the time of 8 ns in the input terminal X2 and the propagation delay time from the input terminal X2 to the output terminal Z2 at the signal fall time is 2 ns, and the signal falls at the time of 10 ns in the input terminal Y2 and the propagation delay tine from the input terminal Y2 to the output terminal Z2 at the signal fall time is 2 ns.

The result analyzing unit 30 analyzes the simulation result in the logic simulation unit 23 (step S15) and judges whether the output signal is of the expected value for the given input signal (step S16). Here, if the output signal is not of the expected value, returning to the step S12 is carried out and a net list is newly generated by logic composing again. If the output signal is of the expected value, the dump file recording unit 26 records the simulation result in the logic simulation unit 23 into the HDD 13. The output unit 21 outputs the simulation result to the display 2 (step S17) and terminates the processing.

In this embodiment, the simulation result is recorded into the HDD 13 in the format shown in FIG. 8. In FIG. 8, the input terminal X1 to the output terminal Z2 are indicated in a horizontal axis, while an elapsed time (unit: ns) since the start of the test is indicated in a vertical axis. The input terminal and output terminal of the logic elements described in the net list shown in FIG. 6 and all the signal changes occurring in the specific points A to C as well as occurring times of those signal changes are recorded in the dump file shown in FIG. 8.

Here, a value “1” shown in FIG. 8 indicates a state that a signal is inputted. A value “0” (zero) indicates a state that a signal is not inputted. “X” in FIG. 8 indicates that a state is indefinite, with a signal not being inputted to the input terminal X1 to the output terminal Z2. Arrows 51 to 54 shown in FIG. 8 will be explained in a specifying action of a propagation path of a signal change described later.

### (Specifying Actions of Propagation Path of Signal Change)

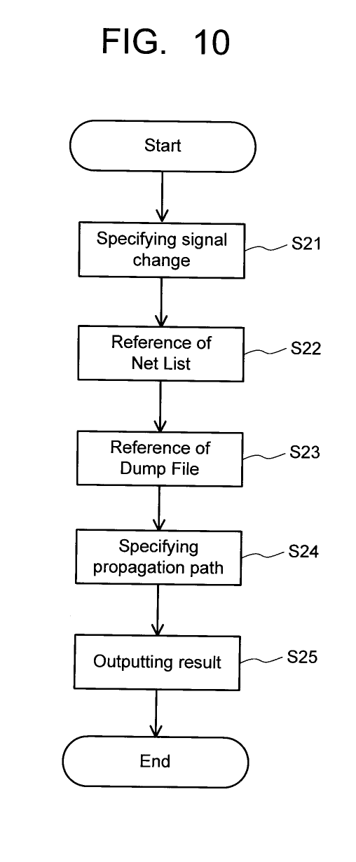

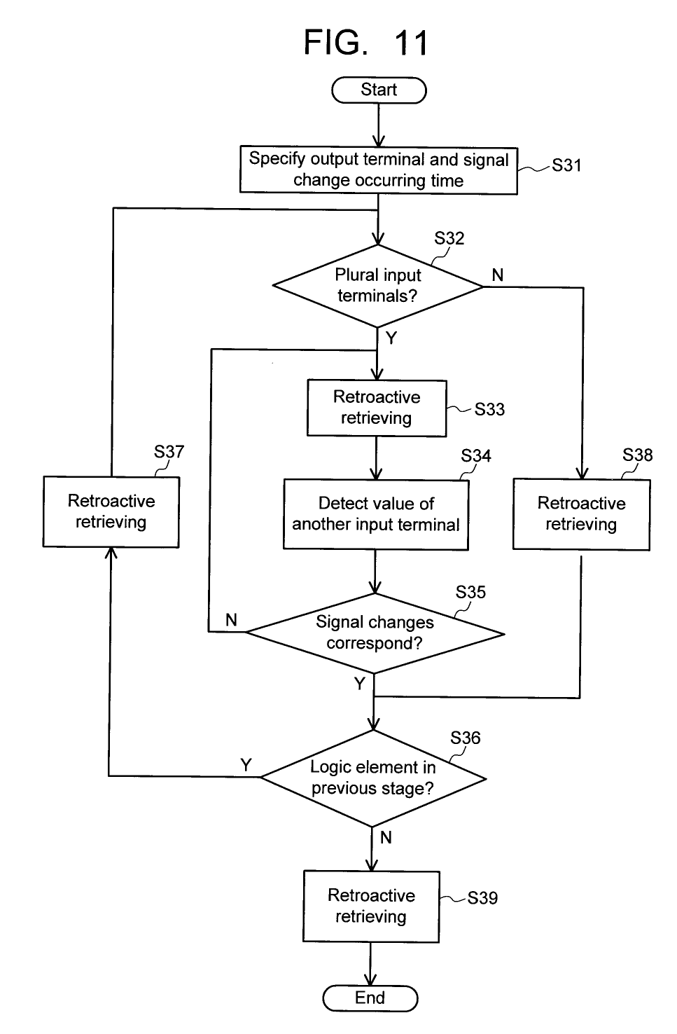

FIG. 10 is a flowchart showing actions of the propagation path specifying device 100 at a specifying time of a propagation path of a signal change. FIG. 11 is a flowchart showing detailed actions of the propagation path specifying unit 24. Here, the actions of the propagation path specifying device 100 in the actions at the signal change propagation path specifying time will be explained by using FIG. 6, FIG. 8, FIG. 10 and FIG. 11.

First, the input accepting unit 20 accepts data to select an arbitrary signal change and outputs the data to the propagation path specifying unit 24 (step S21). Selecting of the arbitrary signal change is performed by selecting an output terminal and a signal change occurring time. A signal line connecting each logic element can be selected instead of the output terminal.

In this embodiment, it is assumed that the output terminal Z2 of the OR circuit 42 at a time of 8 ns and the output terminal Z2 of the OR circuit 42 at a time of 12 ns which are shown in FIG. 8 are selected. Here, (0→1) indicates that a value in the input terminal or output terminal of the logic element or the specific points A to C changes from “0” (zero) to “1”, while (1 0) indicates that the value changes from “1” to “0” (zero).

When the data to select the arbitrary signal change is outputted from the input accepting unit 20, the propagation path specifying unit 24 instructs the net list reference unit 27 to refer to the net list recorded in the HDD 13. Further, the propagation path specifying unit 24 instructs the dump file reference unit 28 to refer to the dump file recorded in the HDD 13. The net list reference unit 27 and the dump file reference unit 28 refer to the net list shown in FIG. 6 and the dump file shown in FIG. 8 which are recorded in the HDD 13, based on the instructions of the propagation path specifying unit 24 (step S22, step S23).

The propagation path specifying unit 24 starts specifying of the propagation path of the selected arbitrary signal change from the information such as the net list and dump file being referred to via the net list reference unit 27 and the dump file reference unit 28 (step S24). (Details of Action of Propagation Path Specifying Unit 24)

Here, the action of the step S24 shown in FIG. 10 will be explained in detail by using FIG. 11. First, specifying of the propagation path of the signal change (0→1) of the output terminal Z2 of the OR circuit 42 at the time of 8 ns will be explained.

The propagation path specifying unit 24 specifies an output terminal and a signal change occurring time in this output terminal from the information of the net list and the data to select the arbitrary signal change outputted from the input accepting unit 20. Here, the propagation path specifying unit 24 specifies the signal change in the output terminal Z2 at the time of 8 ns (step S31).

The propagation path specifying unit 24 judges whether the logic element OR circuit 42 having the specified output terminal Z2 has a plurality of input terminals, from the information of the net list (step S32). Here, the propagation path specifying unit 24 judges that the OR circuit 42 has the plural input terminals.

The propagation path specifying unit 24 retroactively retrieves the signal change most recent from the signal change in the output terminal Z2 at the time of 8 ns from the signal changes occurring in the input terminals X2, Y2 of the OR circuit 42, from the information of the dump file (step S33). Here, the propagation path specifying unit 24 retrieves a signal change (0→1) in the input terminal Y2 at a time of 7 ns.

The propagation path specifying unit 24 detects that a value of another input terminal X2 at an occurring time of the retrieved signal change in the input terminal Y2 at the time of 7 ns is “1”, from the information of the dump file (step S34).

The propagation path specifying unit 24 judges whether the signal change (0→1) in the input terminal Y2 at the time of 7 ns corresponds to the signal change (0→1) in the output terminal z2 at the time of 8 ns by performing a local simulation, based on the detected value “1” of the input terminal X2 and information indicating a correspondence between values of the input terminals X2, Y2 of the OR circuit and a value of the output terminal Z2 of the OR circuit 42, that is, for example, a truth table of the logical sum circuit (step S35).

The local simulation is performed in accordance with the following procedures. First, the propagation path specifying unit 24, with making the value of the input terminal X2 be “1”, generates a test pattern in which the value of the input terminal Y2 is “1”. Next, the propagation path specifying unit 24 recalls a subroutine of the logic simulation unit 23 and gives an instruction to execute the generated test pattern.

The logic simulation unit 23 inputs a signal based on the test pattern generated by the propagation path specifying unit 24 to the OR circuit 42 to execute whether or not the signal change (0→1) occurs in the output terminal Z2. In this local simulation, a propagation delay time is considered. Here, it can be judged from the truth table of the logical sum circuit that the signal change (0→1) does not occur in the output terminal Z2 when the value of the input terminal Y2 is made to be “1” in the state that the value of the input terminal X2 is made to be “1”.

The propagation path specifying unit 24 judges from a result of this local simulation that the signal change in the input terminal Y2 is not propagated to the output terminal Z2. In other words, the propagation path specifying unit 24 judges that the signal change (0→1) in the input terminal Y2 at the time of 7 ns does not correspond to the signal change (0→1) in the output terminal Z2 at the time of 8 ns.

The propagation path specifying unit 24 further retroactively retrieves a signal change occurring in the input terminal of the OR circuit 42 (step S33). Here, the propagation path specifying unit 24 retrieves a signal change (0→1) in the input terminal X2 at a time of 5 ns.

The propagation path specifying unit 24 detects that a value of another input terminal Y2 at an occurring time of the retrieved signal change (0→1) in the input terminal X2 at the time of 5 ns is “0” (zero), from the information of the dump file (step S34).

The propagation path specifying unit 24 judges whether the signal change (0→1) in the input terminal X2 at the time of 5 ns corresponds to the signal change in the output terminal Z2 at the time of 8 ns by performing a local simulation, based on the detected value of the input terminal Y2 and the truth table of the logical sum circuit (step S35). Here, it can be judged from the truth table of the logical sum circuit that the signal change (0→1) occurs in the output terminal Z2 when the value of the input terminal X2 is made to be “1” in the state that the value of the input terminal Y2 is made to be “0”.

The propagation path specifying unit 24 judges from a result of this local simulation that the signal change in the input terminal X2 is propagated to the output terminal Z2 (an arrow 51 shown in FIG. 8). In other words, the propagation path specifying unit 24 judges that the signal change (0→1) in the input terminal X2 at the time of 5 ns corresponds to the signal change (0→1) in the output terminal Z2 at the time of 8 ns.

The propagation path specifying unit 24 judges whether another logic element exists in a previous stage of the input terminal X2, from the information of the net list (step S36). Here, since the AND circuit 41 exists in the previous stage of the input terminal X2, the propagation path specifying unit 24 judges that another logic element exists in the previous stage.

The propagation path specifying unit 24 specifies the output terminal Z1 connected to the input terminal X2 from the information of the net list. Next, the propagation path specifying unit 24 retroactively retrieves the signal change most recent from the occurring time of the signal change in the input terminal X2 at the time of 5 ns among signal changes occurring in the output terminal Z1, from the information of the dump file (step S37). Here, the propagation path specifying unit 24 retrieves a signal change (0→1) of the output terminal Z1 at a time of 4 ns.

Since the output terminal Z1 is one-to-one correspondent to the input terminal X2, the signal change (0→1) in the output terminal Z1 at the time of 4 ns is judged to be propagated to the input terminal X2 (an arrow 52 shown in FIG. 8), and the propagation path specifying unit 24 returns to the step S32.

The propagation path specifying unit 24 judges whether the logic element AND circuit 41 having the output terminal Z1 has a plurality of input terminals, from the information of the net list (step S32). Here, the propagation path specifying unit 24 judges that the AND circuit 41 has the plural input terminals.

The propagation path specifying unit 24 retroactively retrieves the signal change most recent from the occurring time of the signal change in the output terminal Z1 at the time of 4 ns among the signal changes occurring in the input terminals X1, Y1 of the AND circuit 41, from the information of the dump file (step S33). Here, the propagation path specifying unit 24 retrieves a signal change (0→1) of the input terminal X1 at a time of 2 ns (step S33).

The propagation path specifying unit 24 detects that a value of another input terminal Y1 at an occurring time of the retrieved signal change in the input terminal X1 at the time of 2 ns is “1” from the information of the dump file (step S34).

The propagation path specifying unit 24 judges whether the signal change in the input terminal X1 at the time of 2 ns corresponds to the signal change in the output terminal Z1 at the time of 4 ns by performing a local simulation, based on the detected value of the input terminal Y1 and a truth table of the logical multiplication circuit (step S35). Here, it can be judged from the truth table of the logical multiplication circuit that the signal change (0→1) occurs in the output terminal Z1 when the value of the input terminal X1 is made to be “1” in a state that the value of the input terminal Y1 is made to be “1”.

The propagation path specifying unit 24 judges that the signal change in the input terminal X1 is propagated to the output terminal Z1, from a result of this local simulation (an arrow 53 shown in FIG. 8). In other words, the propagation path specifying unit 24 judges that the signal change (0→1) in the input terminal X1 at the time of 2 ns corresponds to the signal change (0→1) in the output terminal Z1 at the time of 4 ns.

The propagation path specifying unit 24 judges whether another logic element exists in a previous stage of the input terminal X1, from the information of the net list (step S36). Here, since the logic element does not exist in the previous stage of the input terminal X1, the propagation path specifying unit 24 judges that another logic element does not exist in the previous stage.

The propagation path specifying unit 24 specifies the specific point A connected to the input terminal X1, from the information of the net list. Next, the propagation path specifying unit 24 retroactively retrieves the signal change most previous from an occurring time of the signal change in the input terminal X1 at the time of 2 ns among the signal changes occurring in the specific point A, from the information of the dump file (step S37). Here, the propagation path specifying unit 24 retrieves a signal change (0→1) in the specific point A at a time of 1 ns.

Since the specific point A is one-to-one correspondent to the input terminal X1, the signal change (0→1) in the specific point A at the time of 1 ns is judged to be propagated to the input terminal X1 (an arrow 54 shown in FIG. 8), and the propagation path specifying unit 24 terminates its action.

Further, in the step S32, if it is judged that the logic element does not have the plural input terminals, the propagation path specifying unit 24 retroactively retrieves the signal change most recent from the occurring time of the signal change in the output terminal among signal changes occurring in the input terminal of that logic element, from the information of the dump file (step S38). Next, since the input terminal and output terminal of the logic element are one-to-one correspondent to each other, the signal change in the input terminal is judged to be propagated to the output terminal, and the propagation path specifying unit 24 proceeds to the step S36. It should be noted that the NOT circuit shown in FIG. 3C is cited as the logic element the input terminal of which is one-to-one correspondent to the output terminal.

The output unit 21 outputs a specifying result of the propagation path of the signal change to the display 2 (step S25). The display 2 displays the propagation path of the signal change specified by the propagation path specifying unit 24 and the signal value in each input terminal and output terminal in a waveform viewer. Further, it is also possible to constitute so that the signal change and the propagation path of this signal change specified by the propagation path specifying unit 24 can be highlight-displayed on the net list shown in FIG. 6 or displayed in a form of text data.

A propagation path of a signal change (1→0) in the output terminal Z2 of the OR circuit 42 at the time of 12 ns can be specified by a similar method. An arrow indicated by a broken line in FIG. 8 shows a result of a specifying processing of the signal change (1→0) of the output terminal Z2 of the OR circuit 42 at the time of 12 ns.

For logic elements such as the NOT circuit, XOR circuit, NOR circuit and NAND circuit which are shown in FIG. 3C to FIG. 3E, the D-type flip-flop shown ion FIG. 4, the multiplexer shown in FIG. 5A, and the half adder shown in FIG. 5B, a propagation path of a signal change having caused an arbitrary signal change can be specified also by the method explained by using FIG. 6, FIG. 8, FIG. 10 and FIG. 11

Further, the logic elements such as the XOR circuit, NOR circuit and NAND circuit which are shown in FIG. 3D to FIG. 3E, the D-type flip-flop shown in FIG. 4, the multiplexer shown in FIG. 5A, and the half adder shown in FIG. 5B and can be replaced by a combination of an AND circuit, an OR circuit and a NOT circuit being basic logic elements. Accordingly, it is possible to specify a propagation path of a signal change having caused an arbitrary signal change after the logic circuit generated in the logic composing unit 22 is replaced by those AND circuit, OR circuit and the NOT circuit.

As explained above, the propagation path specifying unit 100 in the present embodiment does not require information of a pointer to a propagation source or a pointer to a propagation destination of the signal change. As a result, it is possible to specify a propagation path of a signal change having caused an arbitrary signal change with a small amount of information. In addition, since the propagation path of the signal change specified by the propagation path specifying unit 24 and a signal value in each input terminal and output terminal are displayed in a form of a waveform viewer, an action of the logic circuit can be effectively analyzed.

In a case of a sequential circuit such as the flip-flop shown in FIG. 4 and a latch, an input state of an input terminal D is outputted to an output terminal Q at a time of rise or fall of a clock (CK) signal, and the state is kept until rise or fall of the next clock signal. Therefore, propagation of a signal change to the output terminal Q is brought about by the clock signal. However, the clock signal only makes a timing to propagate the signal change in the input terminal D to the output terminal Q. Thus, the propagation path specifying unit 24 according to this embodiment specifies a propagation path of a signal change by detecting a signal change in the input terminal D, not the clock signal.

In a case that it is found signal changes occur simultaneously in a plurality of input terminals in a process of specifying of a propagation path of a signal change by the propagation path specifying unit 24, the plural input terminals should be specified as the propagation paths of the signal change and then the propagation path of the signal change should be further specified for each input terminal. In this case, a plurality of propagation paths is specified, and those plural propagation paths should be displayed in the display 2 as candidates of the propagation path of the signal change.

### Other Embodiments

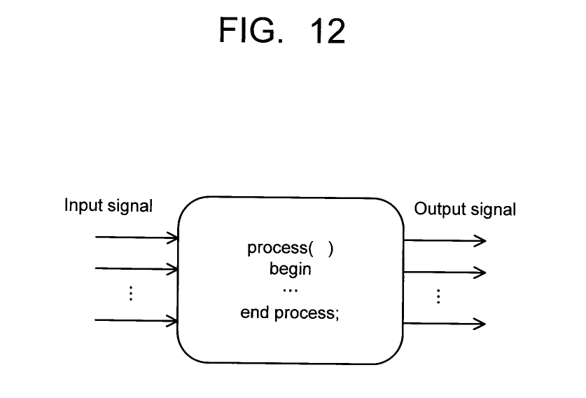

The present invention is not limited to the above-described embodiment, but can be realized by modifying components without departing from the scope and spirit of the invention in an implementation phase. For instance, when verifying rightness of a circuit, a description of an RTL (Register Transfer Level) equivalent to a design of a circuit of an HDL is sometimes used instead of the HDL. FIG. 12 is a diagram showing an example of the description by the RTL. It is also possible to specify a propagation path of a signal change of a logic circuit described by the RTL by a similar method. Further, various inventions can be formed by proper combination of a plurality of components disclosed in the above-described embodiment. For instance, it is possible to eliminate several components from the whole components indicated in the embodiment.

What is claimed is:

1. A propagation path specifying device, comprising:
a storing unit configured to store first information correspondingly indicating signal changes occurring in the input terminals and output terminals of the plurality of logic elements and occurring times of the signal changes;
a storing unit configured to store second information indicating a connection relation among a plurality of logic elements having one or more input terminals and output terminals;
a storing unit configured to store third information indicating a correspondence of signals in the input terminal and output terminal of the logic element;
an input unit configured to input information to select the output terminal of the plurality of logic elements and the occurring time from the first information; and
a propagation path specifying unit configured to specify retroactively a propagation path of the signal change in the selected output terminal and at the selected occurring time, based on the first to third information.

2. The propagation path specifying device of claim 1,
wherein, when judging that the logic element having the selected output terminal has a plurality of the input terminals based on the second information, said propagation path specifying unit retroactively retrieves the signal change most recent from the occurring time of the selected signal change among the signal changes occurring in the plurality of the input terminals, based on the first information.

3. The propagation path specifying device of claim 2,
wherein said propagation path specifying unit detects a signal state of another input terminal at the occurring time of the retrieved signal change based on the first information.

4. The propagation path specifying device of claim 3,
wherein said propagation path specifying unit judges whether or not the retrieved signal change in the input terminal corresponds to the selected signal change in the output terminal, based on the detected signal state of another input terminal and the third information.

5. The propagation path specifying device of claim 1,
wherein the first information is dump file information.

6. The propagation path specifying device of claim 1,
wherein the second information is net list information.

7. A propagation path specifying method, comprising:
inputting, from first information correspondingly indicating signal changes occurring in input terminals and output terminals of a plurality of logic elements having one or more input terminals and output terminals and occurring times of the signal changes, information to select the output terminal of the plurality of logic elements and the occurring time; and
retroactively specifying a propagation path of the signal change in the selected output terminal and at the selected occurring time, based on the first information, second information indicating a connection relation among the plurality of logic elements and third information indicating a correspondence between signals of the input terminal and output terminal of the logic element.

8. The propagation path specifying method of claim 7,
wherein, when judging that the logic element having the selected output terminal has a plurality of the input terminals based on second information, said retroactively specifying the propagation path retroactively retrieves the signal change most recent from the occurring time of the selected signal change among the signal changes occurring in the plurality of the input terminals based on first information.

9. The propagation path specifying method of claim 8,
wherein said retroactively specifying the propagation path detects a signal state of another input terminal at the occurring time of the retrieved signal change based on the first information.

10. The propagation path specifying method of claim 9,
wherein said retroactively specifying the propagation path judges whether the retrieved signal change in the selected input terminal corresponds to the selected signal change in the output terminal, based on the detected signal state of another input terminal and third information.

11. The propagation path specifying method of in claim 7,
wherein the first information is dump file information.

12. The propagation path specifying method of in claim 7,
wherein the second information is net list information.

13. A computer program product, comprising:
a computer readable code for activating a computer to act as a storing unit storing first information correspondingly indicating signal changes occurring in the input terminals and output terminals of the plurality of logic elements and occurring times of the signal changes;
a computer readable code for activating a computer as a storing unit storing second information indicating a connection relation among a plurality of logic elements having one or more input terminals and output terminals;
a computer readable code for activating a computer to act as a storing unit storing third information indicating a correspondence between signals of the input terminal and output terminal of the logic element;
a computer readable code for activating a computer to act as an input unit inputting information to select the output terminal of the plurality of logic elements and the occurring time from the first information; and
a computer readable code for activating a computer to act as a propagation path specifying unit retroactively specifying a propagation path of the signal change in the selected output terminal and at the selected occurring time based on the first to third information.

14. The computer program product of claim 13,
wherein, when the logic element having the selected output terminal is judged to have a plurality of the input terminals based on the second information, the propagation path specifying unit retroactively retrieves the signal change most recent from the occurring time of the selected signal change among signal changes occurring in the plurality of input terminals based on the first information.

15. The computer program product of claim 14,
wherein the propagation path specifying unit detects a signal state of another input terminal at the occurring time of the retrieved signal change, based on the first information.

16. The computer program product of claim 15,
wherein the propagation path specifying unit judges whether the signal change in the retrieved input terminal corresponds to the selected signal change of the output terminal, based on the detected signal state of another input terminal and the third information.

17. The computer program product of claim 13,
wherein the first information is dump file information.

18. The computer program product of claim 13,
wherein the second information is net list information.
